(19) United States
(12) Patent Application Publication
(10) Pub. No.: US 2003/0231335 A1
(43) Pub. Date: Dec. 18, 2003

(54) Distribution of printed information from electronic database

(76) Inventors: Francis E Walsh, Austin, TX (US); David M Read, Williamson County, TX (US)

Correspondence Address: Kelly K Kordzik, Winstead Sechrest & Minick, 5400 Renaissance Tower, 1201 Elm Street, Dallas, TX, 75270, US

(21) Appl. No.: 10/220,943

(22) PCT Filed: Mar. 8, 2001
(86) PCT No.: PCT/US01/07448

(30) Foreign Application Priority Data
Mar. 9, 2000 (US) 60188324

(51) Int. Cl. G06F 15/00; H04N 1/00

(52) U.S. Cl. 358/1.15; 358/402

(57) ABSTRACT

A publication can be received in electronic form and then selected portions clipped with a software editing tool for pasting into a customer's web box. The customer may then view the clipped portion at their leisure. The electronic form of the publication may be created by scanning in the publication. Selected portion can be advertisements and thus provide to the customer as tear sheets. Selected portions can also be searched for using a query to provide an ability to quickly find news clippings desired by the customer.

### TECHNICAL FIELD

The present invention relates in general to information processing systems, and in particular, to Internet distribution to customers of news articles or advertising tear sheets that have been electronically clipped from a database of publications that have been scanned or electronically input to the database.

### BACKGROUND INFORMATION

There are a couple of processes that are performed with respect to the print media industry that remain relatively in the pre-Internet “dark ages”: news-clipping and tear sheets.

News-Clipping

Currently, the print news-article clipping industry process is all done manually. A hard copy of each newspaper or magazine is read by a person visually searching for a client or a client's competitor's name. Once an article is identified, the article is manually clipped and set aside. Another person places a tag on the article identifying the publication and the date of the publication. The news articles are then set aside and periodically mailed to the client. This process can take a week to 10 days. At best, and for a premium fee, news articles are copied and then faxed to the client. Once the client receives the articles in the mail, they need to be put into some order, copied and sent out to other locations, again most often via the U.S. mail.

The current news-clipping industry process is not responsive to the needs of clients in an era in which fast breaking news can have a dramatic effect on an organization. The current process is slow, lacks a high degree of accuracy and provides little help to the organization in terms of distribution to a variety of offices in the United States or around the world.

Tear-Sheets

Print publications, newspapers and magazines that publish advertisements must provide advertisers with “proof of publication” of the advertisements before the advertisers will pay for the advertisements. Currently, these publications provide “tear sheets” of the advertisements to the advertiser. This is done manually by clipping or tearing the advertisements from the publication and then combining the “tear sheets” with an invoice and mailing these to the advertisers via U.S. Mail.

Currently, “tear sheets” are mostly done manually. Some organizations have attempted to solve a portion of this problem. CE Engineering of Lumas, Calif. scans newspapers into a CD ROM and then provides the CD ROM back to the newspaper publisher for them to do tear sheets on-site on their own computers. These tear sheets are then combined with an invoice and mailed to the advertisers. AdPOP (advertising proof of publication) owned by Novus Marketing of Minneapolis, Minn., has a software program that allows publications to create digital documents and process tear sheets for delivery by U.S. Mail. Ad Looks, Inc. scans publications and provides access to advertisers (see www.ad-looks.com).

Both the news-clipping and tear sheet processes are labor intensive, and thus costly, prone to errors, slow, and inconvenient. Therefore, there is a need in the art to improve these services by automation and speedier communication.

### SUMMARY OF THE INVENTION

In accordance with the news-clipping embodiment of the present invention, news articles can be clipped from an electronic database created by scanning print news publications or downloading them via electronic means, and after being annotated with publication name, section and page number. They are then placed on a customer's Internet web box, which can be printed via password. One or all of the clipped news articles can be downloaded from the web box by using an ordinary office printer. After a period of time, the news articles are archived on a CD-ROM. Accounting and management functions have been automated and integrated into the invention.

In accordance with the tear sheet embodiment of the present invention, the publication can be received digitally from the publisher, advertisements identified and electronically clipped, and placed into each advertiser's web box within a specified web site. The advertiser's web box is accessible and protected by password. The advertiser's web box contains each advertisement run in the publication, all relevant data about the advertisement (publication name, date, section, page number, size of advertisement in column inches, invoice number and cost of advertisement). The clipping software can be integrated with the publication's accounting software to provide cost of specific advertisements and total cost of advertisements for the billing period.

The web box page showing the clipped advertisement can include an interactive space allowing advertiser and publication personnel to communicate concerning the advertisement. The advertisement may be forwarded to other locations by the advertiser using e-mail. As advertiser and publication personnel work together for a finished product to appear in the publication, the draft of the advertisement can be transmitted back and forth via the advertiser's web box. With the draft of the advertisement on the web page, advertiser and publication personnel can communicate via an e-mail capacity on the same page with the draft. Changes can be requested, made and final approval acquired quickly. Once final approval is given, the advertiser selects the approval button on the page and this provides the publication with a legal Internet signature. The advertisement can then be forwarded to the appropriate page in the publication.

Accordingly, several objects and advantages of the present invention are:

(a) to scan into a database or to receive digitally a significantly large number of newspapers and news magazines;

(b) to OCR and index the news database;

(c) to computer search the database for words or phrases according to the client objectives thus significantly increasing the accuracy of the search when compared to manual readers;

(d) to identify and bring to the computer screen specific news articles via search requirements;

(e) to clip the news articles and place them into the client's web box automatically annotated with the publication's name, section and page number attached;

(f) to present news articles in an organized fashion in the web boxes according to the client's need to review news articles;

(g) to provide the client with ability to access the web box via a password and print one or more of news articles from an ordinary office printer; (steps (a) through (g) may be accomplished daily);

(h) to store news articles in a web box over a period of time and then provide the client with a CD-ROM of the news articles in the same order that they were being held in the web box;

(i) to provide back searches of the database for articles that were not requested in current time;

(j) to provide advertising searches for clients who want to compare what level and kinds of advertising one or more competitors are doing;

(k) to bring together single subject compilations from large numbers of publications so that the coverage of the single subject can be quickly reviewed and understood by a client; and

(l) to provide phrase searches of two or more words (i.e., airline ticket price increase, voter turnout, etc.).

The foregoing advantages can be accomplished on the same day as the publication is published, making the information available in “real time.”

Further objects and advantages are to provide invoicing data for each client's account by having the invoice database automatically updated each time a news clip is added to the web box and delivering the invoice via e-mail at the end of each accounting period, and to provide the supervisor of several editing positions with an on-going count of each position's clip totals so that each position can be monitored for profitability during the work period.

Further objects and advantages of the tear sheet embodiment are:

(a) to replace a manual process with an electronic process;

(b) to electronically clip all advertisements and provide them to advertisers as legal proof of publication;

(c) to integrate the process with a publication's accounting software to provide advertisers with current and on-going advertising costs;

(d) to provide the advertiser and the publication with e-mail communications procedures on the same pages as the advertisement of the web box giving advertisers and the publication's personnel real-time reconciliation opportunities if they are needed; and

(e) to provide for quick, interactive communication between the advertiser and the publication as the advertisement is created, ending with an Internet signature of final approval.

The present invention takes a highly personnel intensive, costly, manual process to the Internet where the process is accomplished faster, integrates accounting data, invoices electronically, and distributes this information anywhere in the world. The proofing function provides a faster and more accurate solution to courier and faxing now being used.

The foregoing has outlined rather broadly the features and technical advantages of the present invention in order that the detailed description of the invention that follows may be better understood. Additional features and advantages of the invention will be described hereinafter which form the subject of the claims of the invention.

### BRIEF DESCRIPTION OF DRAWINGS

For a more complete understanding of the present invention, and the advantages thereof, reference is now made to the following descriptions taken in conjunction with the accompanying drawings, in which:

FIG. 1 is an overview of an embodiment of the present invention;

FIG. 2 is a flow diagram illustrating a process of adding documents to the database;

FIG. 3 is a flow diagram illustrating a process of clipping news clips and tear sheets (hereinafter referred collectively as “clips”) from the database and placing the clips into the client's web box;

FIG. 4 is a flow diagram illustrating a process a client uses to access, view, and print clips stored in the web box;

FIG. 5 is a flow diagram illustrating accounting and management tools used to manage the news clipping/tear sheet process;

FIG. 6 is a data processing system capable of implementing the present invention;

FIG. 7 illustrates a block diagram in accordance with the present invention;

FIG. 8 illustrates a flow diagram in accordance with the present invention;

FIG. 9 illustrates a network password dialogue block for entering the tear sheet process of the present invention; and

FIGS. 10-17 illustrate web pages configured in accordance with the steps of the tear sheet process of the present invention.

### DETAILED DESCRIPTION

In the following description, numerous specific details are set forth to provide a thorough understanding of the present invention. However, it will be obvious to those skilled in the art that the present invention may be practiced without such specific details. In other instances, well-known circuits have been shown in block diagram form in order not to obscure the present invention in unnecessary detail. For the most part, details concerning timing considerations and the like have been omitted in as much as such details are not necessary to obtain a complete understanding of the present invention and are within the skills of persons of ordinary skill in the relevant art.

Refer now to the drawings wherein depicted elements are not necessarily shown to scale and wherein like or similar elements are designated by the same reference numeral through the several views.

News-clipping and tear sheets have been performed manually for years. The present invention replaces much of the labor intensive tasks with an automated system. As will be described hereinafter, the present invention is capable of implementing systems for both the news-clipping and the tear sheet process.

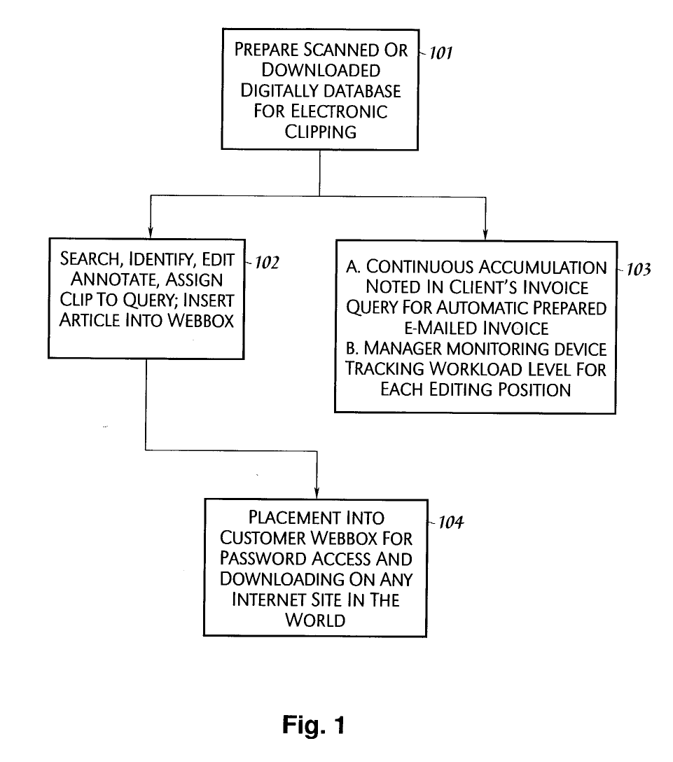

Referring to FIG. 1, the system in block 101 provides for a central depository (database) including the process of scanning regular and over-sized publications (or downloaded digitally into the database), providing optical character recognition (OCR) and indexing being entered into the database. Essentially, process 101 involves scanning publications (or receiving them digitally) into a database of text and image files, whereby the text is placed in a text file and each page of the publication is placed in an image file pertaining to the publication. For each page of the publication, the text and image files can be cross-linked to each other. In process 102, the database (text file) can be searched with word searches in accordance with a requested search query; when words are identified on a page, the entire page (image file) is displayed on the computer screen; the specific clip with the word is visually identified and electronically clipped from the image file and assigned to the search query; the clip is then placed into the client's web box. While the 102 process is being performed, two important management functions 103 may be performed: (1) as each clip is processed for a client, it is automatically noted in the client's invoice application so that at the end of an invoice period, the invoice is automatically ready to be sent to the client via e-mail, thus eliminating much of the manual accounting function of an office; and (2) each clip position (employee performing clipping) is monitored by providing a manager with how many clips have been made in each position at any time during the work day. On the client side of this invention 104, the customer has an individually designed web box into which clips are placed. The client, and anyone whom the client has given a password, can access the web box from any location in the world where access to the Internet is available, view individual clips, print individual clips using an ordinary office printer, or download clips into a computer and distribute them via e-mail.

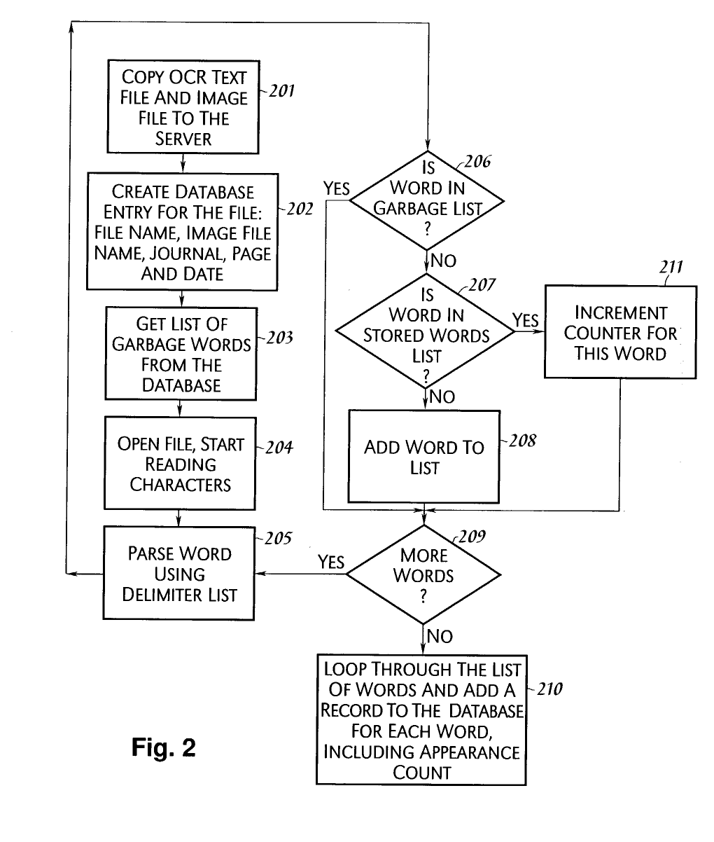

Referring to FIG. 2, there is illustrated a process for adding documents (or entire publications) to the database discussed with respect to FIG. 1. The process begins in step 201 with digitally downloaded publications or the scanning of the publications, optical character recognition (OCR) of the text from the publications to create the text file, and indexing of the image file of the publications into the server. Once in the server, in step 202, the file name, image file name, journal page and date are added. From this complete database, in step 203, a list of garbage words are retrieved from the database. Garbage words are words such as “the,” “and,” etc., that are not particular to the subject matter of the clip in which they reside. Once the file is open in step 204, the process of reading characters can begin and words can be separated (parsed) in step 205 using the delimiter list. The delimiter list (garbage list) is created by the programmer. The next step 206 is a check to determine whether a read word is in the garbage list. If the word is in the garbage list, the process can jump from step 206 to step 209. If not, step 207 determines whether the word is already stored in the stored words list (words that are not garbage words) for a particular page of the publication. If the word is not in the stored word list, it can be added in step 208 at this point. If the word is already in the list of stored words, a counter that tracks how many times the word appears is incremented in step 211. If more words need to be added, the process in steps 205 through 209 can be repeated. Once this process is complete in step 210, the operator loops through the list of words and adds a record to the database for each word. Such a record may include a hyperlink to the client. Additionally, this step prepares the word database for the search function.

It should be noted that the clipping from scanned publications or digitally downloaded publications can be supplemented with periodicals from on-line sources, the Internet, and streaming video. Furthermore, a translation function can be added so that foreign documents and Internet websites in foreign languages can be translated for the client.

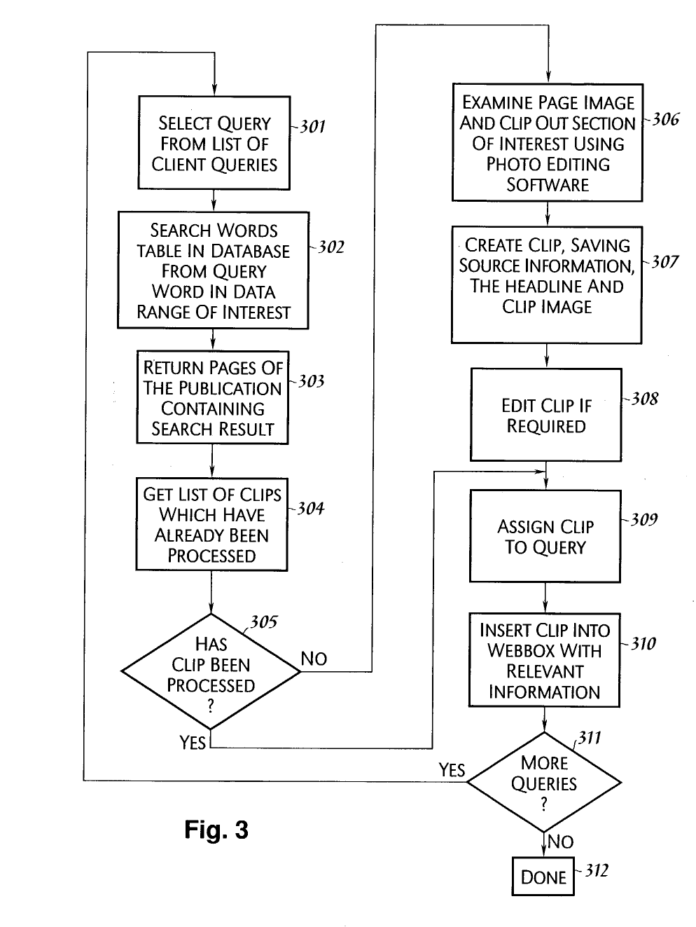

FIG. 3 illustrates the clipping process of the present invention. The process allows for an operator to select in step 301 a query from the list of client queries (a list of words provided by the client). The searching process in step 302 begins searching the words table in the database (see step 210) from query word(s) within a date range indicated. (Since each word in the words database has an associated publication date, the query can be limited to a specified date range.) Once the search is completed, the invention returns in step 303 pages of the publication containing all of the search results. The portion of the process ends in step 304 with a list of all the clips in the database which the query generates, including noting those clips that have already been processed. For example, if the advertiser is Foodmart, the query word would be Foodmart, and all ads with the word Foodmart would be listed for clipping. The same process would be used for newsclips.

The next step 305 goes through each clip to determine if it has been processed. If a clip has been processed, in step 309 a mouse click on the clip automatically sends it to be assigned to the client. If the answer to the question in step 305 is NO, then in step 306, the operator examines the image file of the publication page in which the clip appears and edits (cuts) the clip from the page using photo editing software. The clip is then created (electronically copied) in step 307 and a headline is added (assigned to the file) to the clipped image. The clip is then edited in step 308 if required and assigned to the client's query in step 309. Editing may be performed to append sections of an clip together when the sections are on different pages of the publication, or to make the clip more presentable. The clip is then electronically inserted into the client's web box file with relevant information in step 310. Steps 305-310 can be repeated for each clip pertaining to a query. If more queries are required in step 311, the operator repeats steps 305 through 310. If there are no more queries required, the process is complete in step 312.

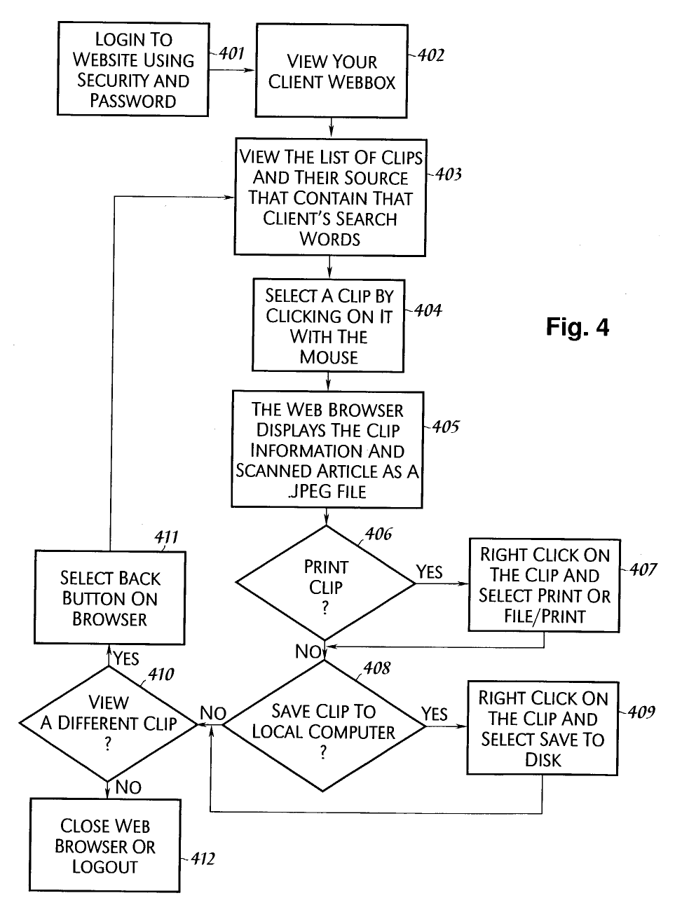

FIG. 4 illustrates a process that provides the client with access to a web box using security and a password in step 401. The view in step 402 of the client web box moves directly to a list of clips in step 403 that illustrates the client's search words (used by operator in query described in FIG. 4) and web box organizational pattern they have selected. At this point, the client can select any clip in step 404 by clicking on it with a mouse. As described above, such clips were placed in the web box in step 310. In step 405, the web browser displays the clip information (publication, section, page and date) and scanned article as a jpeg file. The client now has the choice to print the clip in step 406 by right clicking on the clip and selecting print in step 407 (or selecting “print” from the File menu) or saving the clip to a local computer in step 408 by right clicking on the clip and selecting save to disk in step 409 (or selecting “save” from the File menu). The client may print the clip in step 406 or save to a local computer in step 408 or just go on to view a different clip in step 410. If the client wants to see other clips, this is done by selecting the back button on the browser in step 411 which returns the client to step 403 which is a list of all the clips available to the client. If the client is finished with the web box, the client can close the browser or logout in step 412.

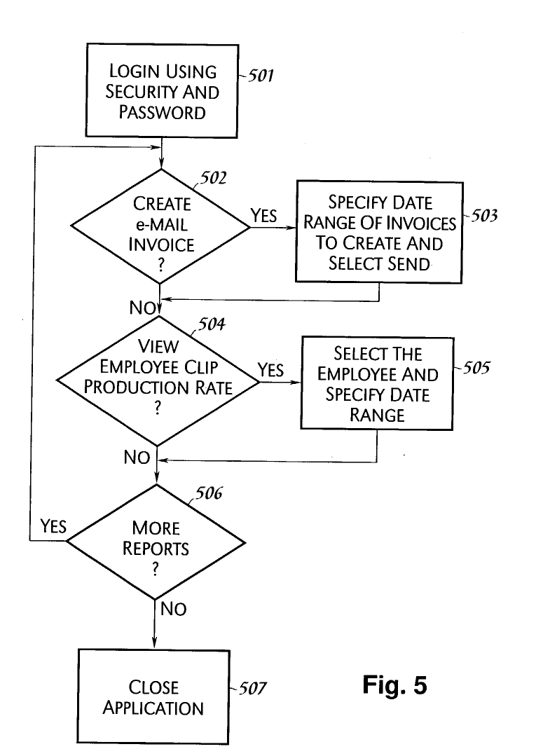

FIG. 5 illustrates a process that provides additional accounting and management functions. An accounting or management user logs in using security and password in step 501. As an operator performs the clipping function in steps 301 through 311, the software, in step 502, automatically adds each clip to an invoice to be sent to the client at the end of the invoice period in step 503. The invoice has within it specific client data relating to cost of services which are automatically tabulated and totaled during the invoice period. The completed invoice is automatically sent via e-mail to each client. This invention also provides a management function in which managers can track an operator's rate of clipping during any period of the day, week or month. As operators make clips for a client, a separate tally is automatically kept on each operator and in step 504 is available on the manager's computer. The manager simply selects a specific operator and the time period of measurement in step 505 and the computer provides a tally for that operator for that time period. If invoice data needs to be added, changed, or additional operator reports desired, the manager in step 506 begins the process with either invoices or operator tallies. If the manager is finished with these functions, the application can be closed in step 507.

Thus, the reader will see that the scanning, electronic clipping and internet distribution of the invention moves the print news clipping and tear sheet industry from a completely manual process to a highly technical process using computer and Internet driven technology to make the process a more accurate, timely and cost effective with a multitude of value-added services not now available with the manual process.

Furthermore, the invention breaks all geographical barriers in that databases or scanning done anywhere in the world can be gathered at a central location; the clipping function performed and distribution anywhere on the world wide web. Again, this is done daily. The accounting and management functions have also been added to take advantage of computer technology.

In addition, with the print publications in a database, publications in a variety of languages can be computer translated for the convenience of clients who prefer a translation different than the original publication language.

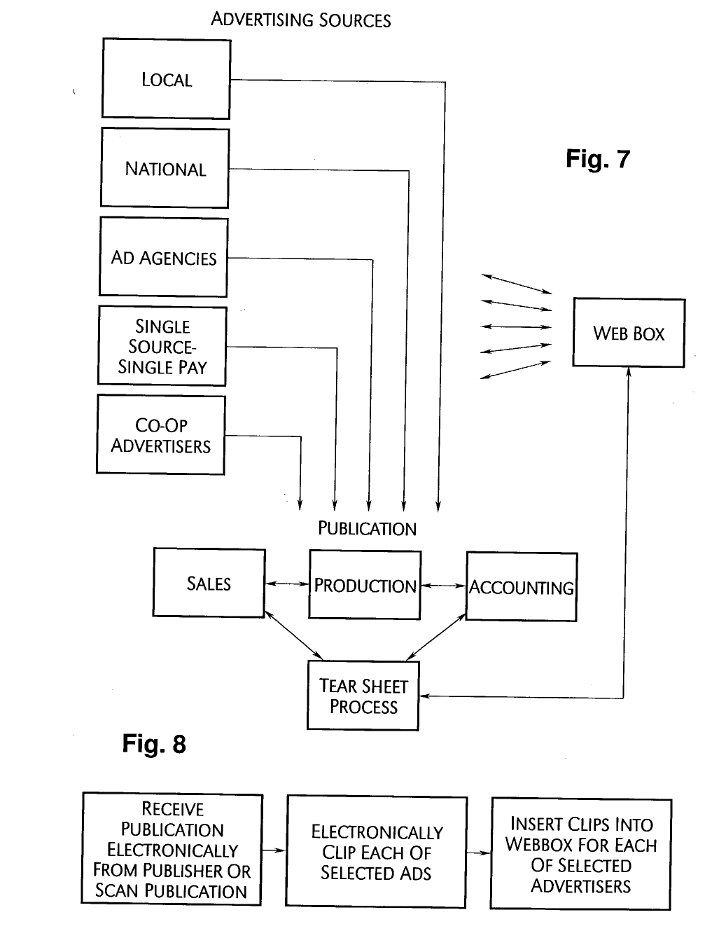

Referring to FIG. 7, there are a variety of advertising sources that could possibly feed advertising into the sales operations of a publication. An example of a local advertising source would be a local company within a city where a publication is distributed. A national advertising source might be a company having a national presence. Companies often hire advertising agencies to handle their advertising needs. A single source-single pay advertising source is as the name implies. And, co-op advertisers is when companies cooperate to both have a presence within an ad.

Advertising sources require a tear sheet (advertisement as published) as proof of publication prior to paying an invoice to the publication. Today, tear sheets are typically manually clipped. About 25% of advertisers require a daily clipping of the tear sheet for use in their marketing activities. For example, a business might want to display their ad being run in a newspaper within the store within the same day that the ad is published in the newspaper. Furthermore, 100% of the advertisements will be clipped by the accounting department and sent with a monthly invoice to the advertising source.

Using the same electronic file that is used to print a publication, the tear sheet process of the present invention enables employees to clip 100% of a publication's advertisements within a few hours each day. The electronic tear sheets then can be automatically placed on a web page (web box) of an advertising source via a typical browser distribution. Advertising sources may then download and/or distribute the electronic tear sheets. The advantages of electronic tear sheets are numerous.

Referring to FIG. 8, if the electronic tear sheet process of the present invention is performed by a service provider for a publication, e.g., outsourced to a service provider by the publication, then the publication can be provided in print form or electronic form to the service provider, much in the same way as described above with respect to FIGS. 1 and 2 with the news-clipping process. If a printed publication is provided, then it will have to be scanned in as described above. An electronic version of the publication eliminates the scanning process.

Then, for each advertising source, the advertisements can be clipped and then inserted into the web box for each advertiser. These processes are performed much in the same manner as described above with respect to the news-clipping process. Furthermore, the tear sheet clipping process can also be performed internally by the publication, instead of outsourcing the process to a vendor.

The present invention also provides some added benefits when the electronic tear sheet clipping process is integrated with the publication's accounting software to provide cost of specific advertisements and total cost of advertisements for a billing period. Furthermore, the electronic tear sheet process can also be integrated into the functions performed by the sales and production staffs to enable a more efficient and accurate creation and publication of advertisements for customers.

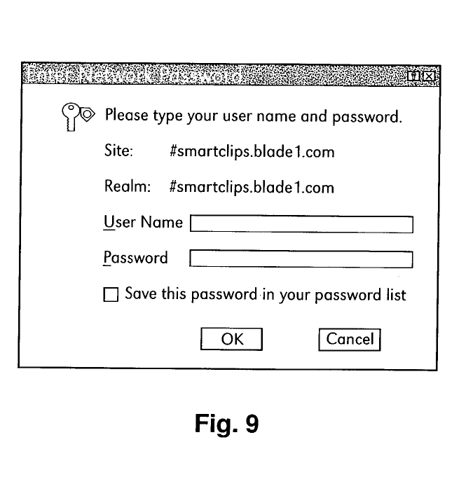

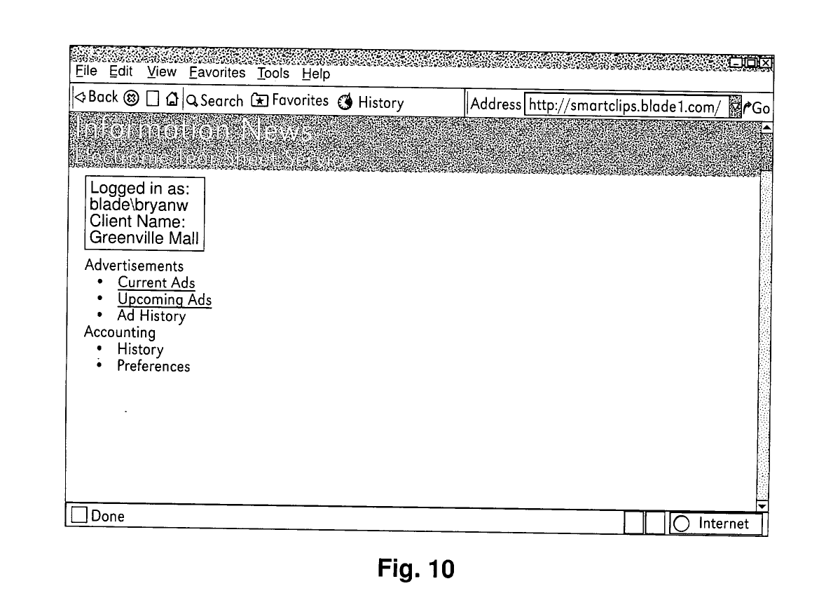

As advertiser and publication personnel work together for a finished product (ad to be published) to appear in the publication, the draft of the advertisement can be transmitted back and forth via the web box illustrated in FIG. 7. Referring to FIG. 9, an enter network password dialog box can be used to enable an advertising source to enter the web box in a controlled manner. FIG. 10 illustrates an example of the next web page that is displayed to the advertising source. Hyperlinks are shown to enable the advertising source to view any “Current Ads” running within the publication for that advertising source, and any “Upcoming Ads” (proposed ads) to be reviewed and approved by the advertising source. An Ad History, and other accounting information can also be included for viewing.

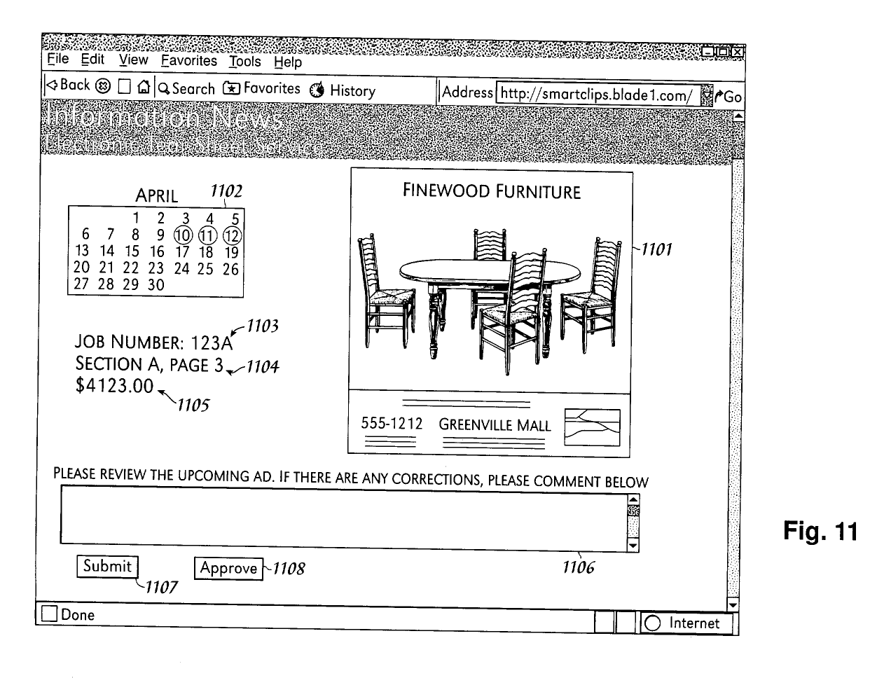

As an example, after the advertising source mouse-clicks on the Upcoming Ads hyperlink, the web page in FIG. 11 may be displayed. The web page of FIG. 11 illustrates an ad created by the production staff of the publication for review by the advertising source. Additionally, a calendar 1102 can be shown on the web page indicating what days the ad will be published with the publication, which in this example would be the dates of April 10-12. Also shown is a job number 1103, the section and page 1104 of the publication in which the ad will appear, and the cost 1105 for the ad for the dates shown. Further, an e-mail box 1106 is provided on the web page to enable the advertising source to provide any comments with respect to the proposed ad 1101. An Approve button 1108 is provided for the advertising source to approve of the upcoming ad 1101, the dates it will be published, the location of the publication of the ad 1104, and the price for the ad 1105. The submit button 1107 permits the advertising user to submit any comments or an approval to the publication.

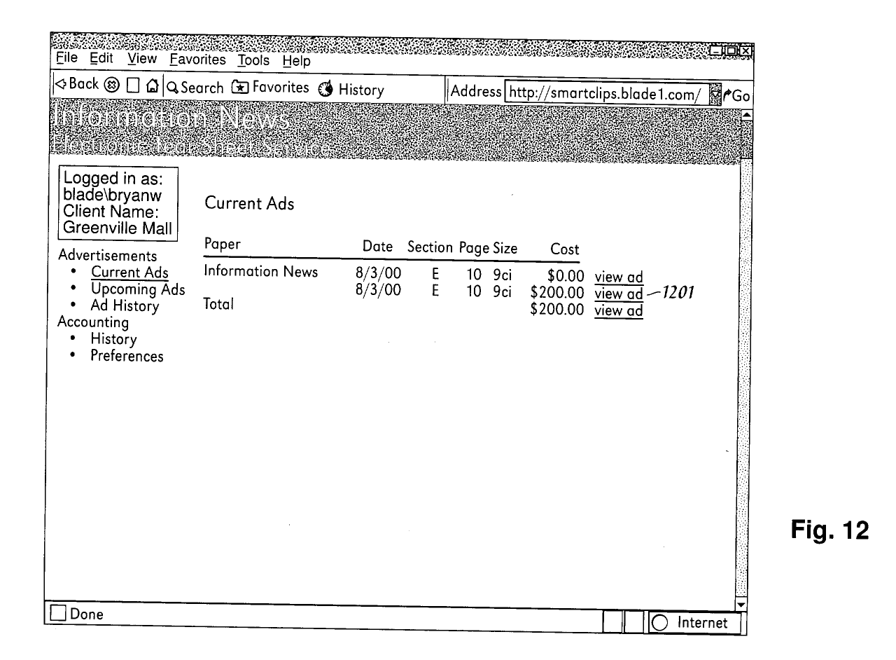

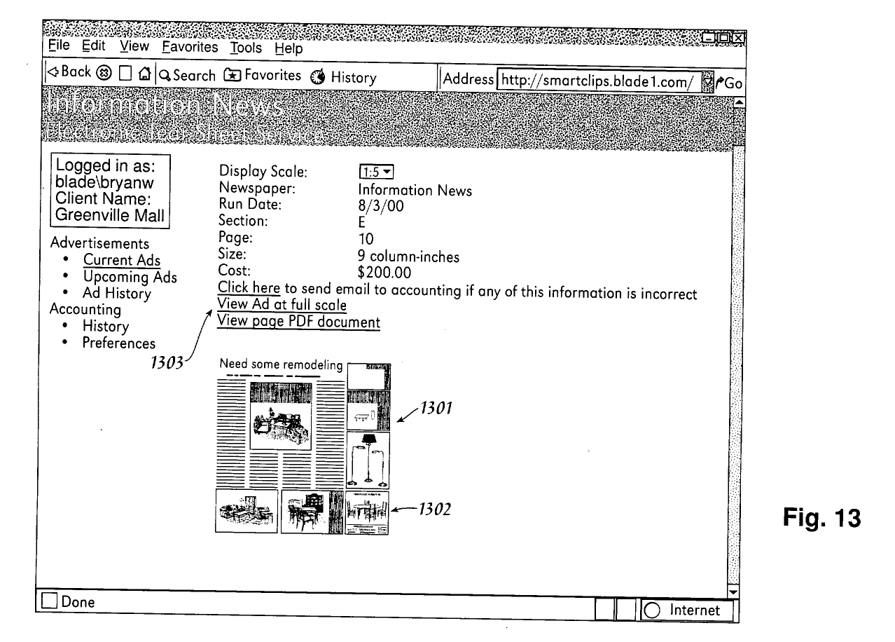

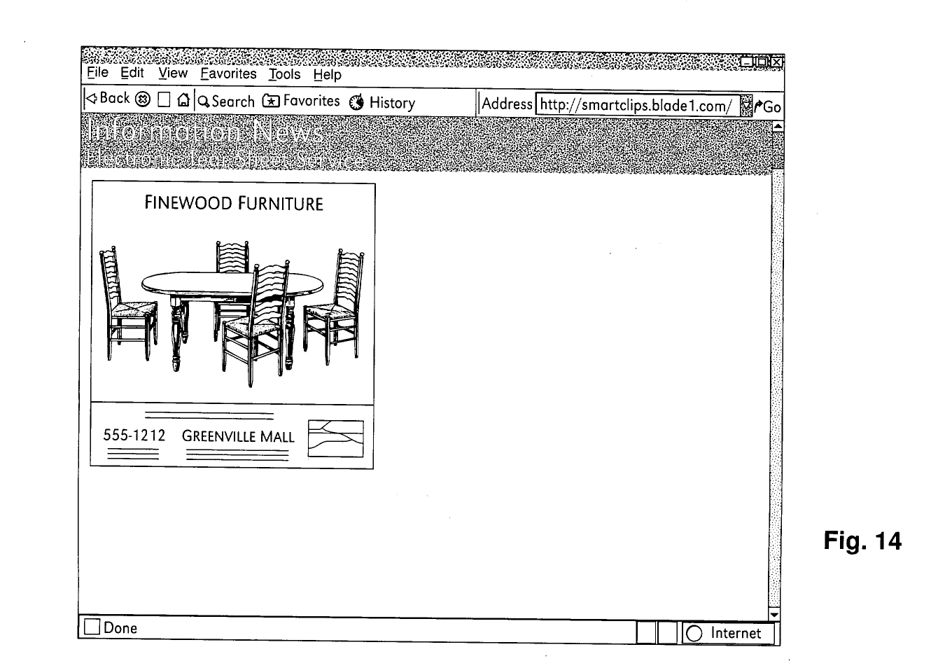

If the advertising source then returns to the web page of FIG. 10, the advertising source can mouse click on the Current Ads hyperlink, resulting in the web page of FIG. 12 being displayed. In this example, it is shown that an ad was ordered for publication on Aug. 3, 2000 in section E, page 10, having a size of nine column-inches at a cost of $200. A View Ad hyperlink 1201 can be mouse-clicked by the advertising user resulting in the display of the web page of FIG. 13. Shown will be the page 1301 of the publication, which in this example is page 10 of section E, which shows the nine column-inch ad 1302 positioned on that page 1301 of the publication. If hyperlink 1303 is mouse-clicked, then a full-scale image of the ad 1302 will be displayed on another web page shown in FIG. 14.

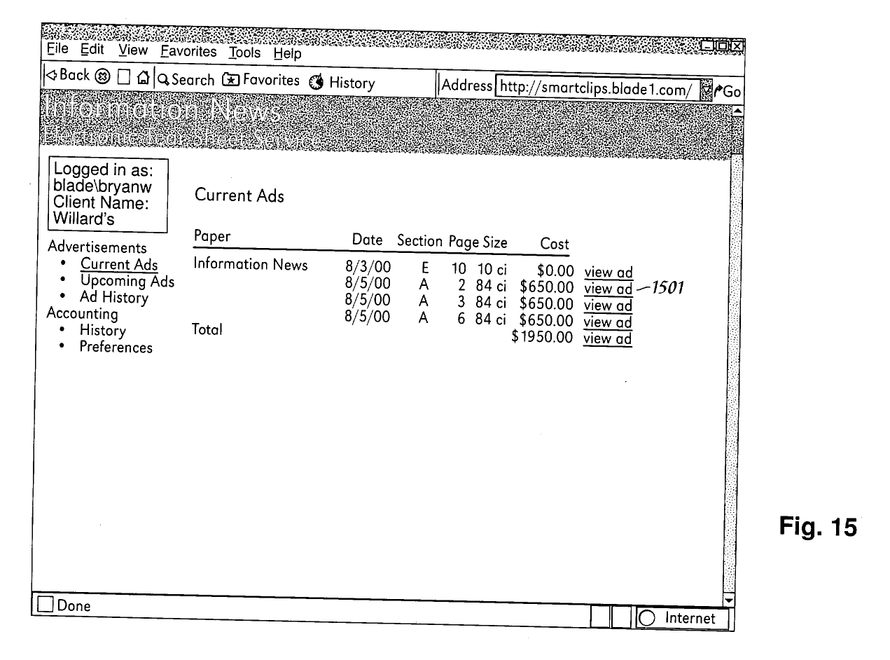

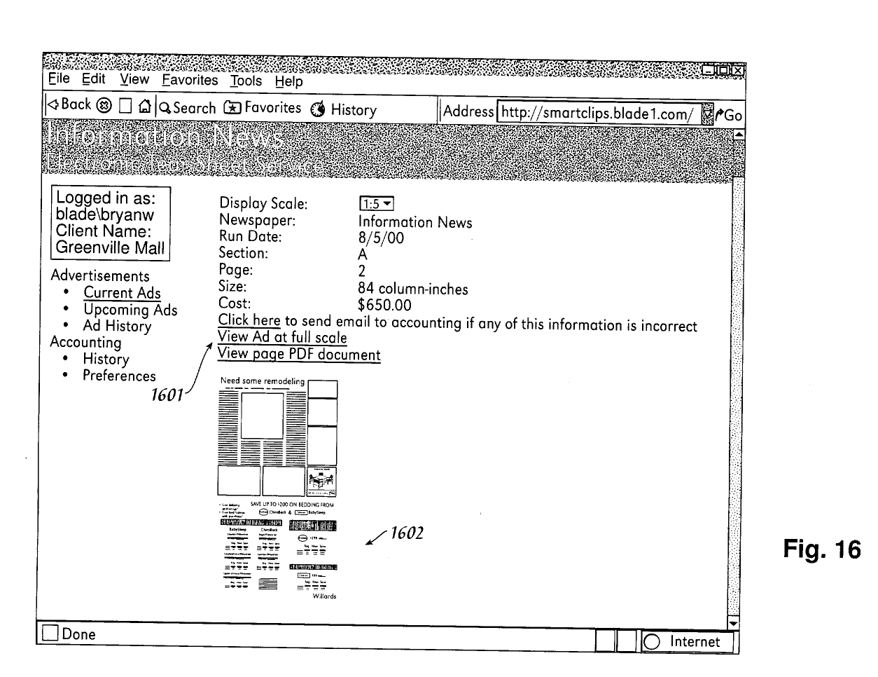

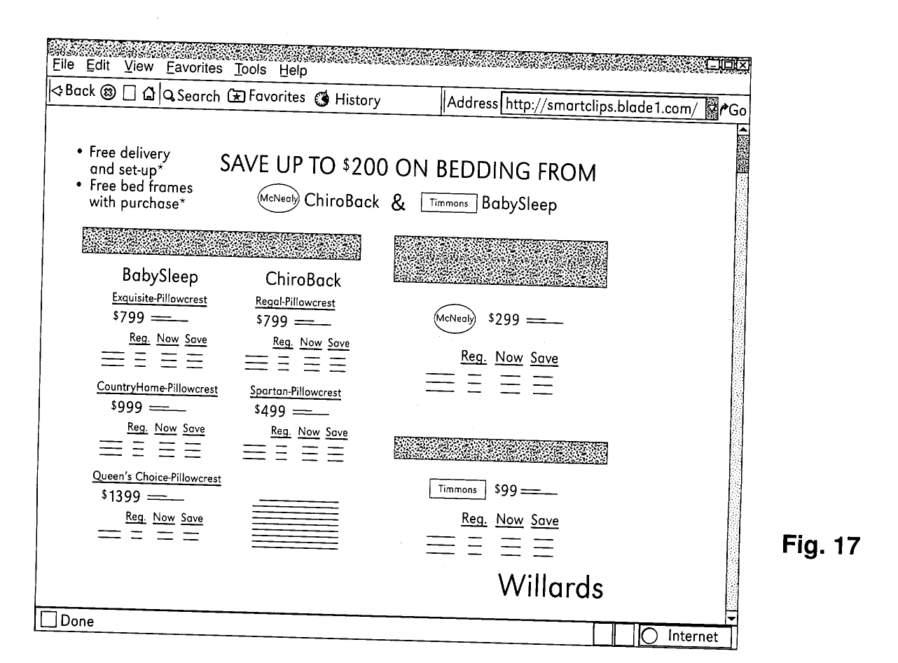

Returning to FIG. 10, another example of a Current Ads hyperlink can occur resulting in the web page of FIG. 15 being displayed to the advertising source. FIG. 15 shows another example of Current Ads for an advertising source. A mouse click on one of the “View Ad” hyperlinks 1501 could result in the web page of FIG. 16 being displayed, which shows an example of a co-op advertisement. Either clicking on the ad 1602 or on the “View Ad at full-scale” hyperlink 1601 would result in the web page of FIG. 17 being displayed.

One skilled in the art would be able to create a program leading through the steps described with respect to FIGS. 9-17.

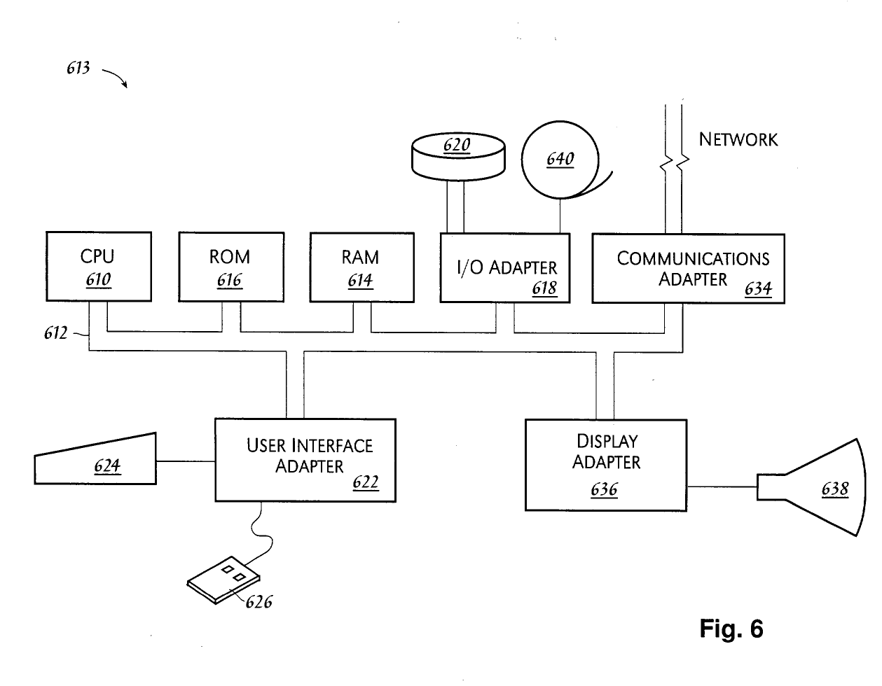

Referring to FIG. 6, an example is shown of a data processing system 600 which may be used for the invention. The system has a central processing unit (CPU) 610, which is coupled to various other components by system bus 612. Read only memory (“ROM”) 616 is coupled to the system bus 62 and includes a basic input/output system (“BIOS”) that controls certain basic functions of the data processing system 600. Random access memory (“RAM”) 614, I/O adapter 618, and communications adapter 634 are also coupled to the system bus 612. I/O adapter 618 may be a small computer system interface (“SCSI”) adapter that communicates with a disk storage device 620. Communications adapter 634 interconnects bus 612 with an outside network enabling the data processing system to communicate with other such systems. Input/Output devices are also connected to system bus 612 via user interface adapter 622 and display adapter 636. Keyboard 624 and mouse 626 are inter-connected to bus 612 via user interface adapter 622. Display monitor 638 is connected to system bus 612 by display adapter 636. In this manner, a user is capable of inputting to the system throughout the keyboard 624, or mouse 626 and receiving output from the system via display 638.

Implementations of the invention include implementations as a computer system programmed to execute the method or methods described herein, and as a computer program product. Thus, system 600 could be configured to run software (or a combination of hardware and software) programmed according to the flow diagrams of FIGS. 1-5, or the steps depicted with respect to FIGS. 7-17. According to the computer system implementation, sets of instructions for executing the method or methods are resident in the random access memory 614 of one or more computer systems configured generally as described above. Until required by the computer system, the set of instructions may be stored as a computer program product in another computer memory, for example, in disk drive 620 (which may include a removable memory such as an optical disk or floppy disk for eventual use in the disk drive 620). Further, the computer program product can also be stored at another computer and transmitted when desired to the user's workstation by a network or by an external network such as the Internet. One skilled in the art would appreciate that the physical storage of the sets of instructions physically changes the medium upon which it is stored so that the medium carries computer readable information. The change may be electrical, magnetic, chemical, biological, or some other physical change. While it is convenient to describe the invention in terms of instructions, symbols, characters, or the like, the reader should remember that all of these and similar terms should be associated with the appropriate physical elements.

Note that the invention may describe terms such as comparing, validating, selecting, identifying, or other terms that could be associated with a human operator. However, for at least a number of the operations described herein, which form part of at least one of the embodiments, no action by a human operator is desirable. The operations described are, in large part, machine operations processing electrical signals to generate other electrical signals.

Although the present invention and its advantages have been described in detail, it should be understood that various changes, substitutions and alterations can be made herein without departing from the spirit and scope of the invention as defined by the appended claims.

What is claimed is:

1. An information clipping method comprising the steps of:
receiving a digital file of a publication;
searching the digital file using a search query;
displaying a page of the publication as a result of the searching step, wherein the page contains a word found by the search query;
performing a software clipping of a selected portion of the page of the publication containing the word; and
inserting the selected portion clipped from the page of the publication into a webbox.

2. The method as recited in claim 1, further comprising the step of scanning a printed version of the publication to create the digital file.

3. The method as recited in claim 1, wherein the searching step further comprises the steps of:
reading each word in the digital file;
excluding garbage words;
creating a database of words read from the digital file exclusive of the garbage words; and
performing the searching step using the search query on the database of words.

4. The method as recited in claim 1, further comprising the step of:
displaying an image of the selected portion to a user accessing the webbox.

5. A system comprising:
circuitry for receiving a digital file of a publication;
circuitry for searching the digital file using a search query;
circuitry for displaying a page of the publication, wherein the page contains a word found by the search query;
circuitry for performing a software clipping of a selected portion of the page of the publication containing the word; and
circuitry for inserting the selected portion clipped from the page of the publication into a webbox.

6. The system as recited in claim 5, further comprising a scanner for scanning a printed version of the publication to create the digital file.

7. The system as recited in claim 5, wherein the searching circuitry further comprises:
circuitry for reading each word in the digital file;
circuitry for excluding garbage words;
circuitry for creating a database of words read from the digital file exclusive of the garbage words; and
circuitry for performing the search query on the database of words.

8. The system as recited in claim 5, further comprising:
circuitry for displaying an image of the selected portion to a user accessing the webbox.

9. An information clipping method comprising the steps of:
receiving a digital file of a publication;
displaying a page of the publication accessed from the digital file, wherein the page contains an advertisement;
performing a software clipping of the advertisement; and
inserting the advertisement clipped from the page of the publication into a webbox.

10. The method as recited in claim 9, further comprising the step of scanning a printed version of the publication to create the digital file.

11. The method as recited in claim 9, further comprising the step of:
displaying an image of the advertisement to a user accessing the webbox.

12. A system comprising:
circuitry for receiving a digital file of a publication;
circuitry for displaying a page of the publication accessed from the digital file, wherein the page contains an advertisement;
circuitry for performing a software clipping of the advertisement; and
circuitry for inserting the advertisement clipped from the page of the publication into a webbox.

13. The system as recited in claim 12, further comprising circuitry for scanning a printed version of the publication to create the digital file.

14. The system as recited in claim 12, further comprising: circuitry for displaying an image of the advertisement to a user accessing the webbox.

15. An information clipping method comprising the steps of:
receiving a digital file of a publication;
searching the digital file using a search query;
selecting a page of the publication as a result of the searching step, wherein the page contains a word found by the search query;
performing a software clipping of a selected portion of the page of the publication containing the word; and
outputting an electronic file of the selected portion clipped from the page of the publication.

16. The method as recited in claim 15, wherein the searching step further comprises the steps of:
reading each word in the digital file;
excluding garbage words;
creating a database of words read from the digital file exclusive of the garbage words; and
performing the searching step using the search query on the database of words.

17. The method as recited in claim 15, wherein the step of outputting the electronic file of the selected portion clipped from the page of the publication further comprises the step of inserting the selected portion clipped from the page of the publication into a webbox.

18. The method as recited in claim 17, further comprising the step of displaying an image of the selected portion to a user accessing the webbox.

19. An information clipping system comprising:
means for receiving a digital file of a publication;
means for searching the digital file using a search query;
means for selecting a page of the publication in response to the search query, wherein the page contains a word found by the search query;
means for performing a software clipping of a selected portion of the page of the publication containing the word; and
means for outputting an electronic file of the selected portion clipped from the page of the publication.

20. A system comprising:
circuitry for receiving a digital file of a publication;
circuitry for searching the digital file using a search query;
circuitry for displaying a page of the publication, wherein the page contains a word found by the search query;
circuitry for performing a software clipping of a selected portion of the page of the publication containing the word; and
circuitry for inserting the selected portion clipped from the page of the publication into a webbox.

21. The system as recited in claim 20, further comprising a scanner for scanning a printed version of the publication to create the digital file.

22. The system as recited in claim 20, wherein the searching circuitry further comprises:
circuitry for reading each word in the digital file;
circuitry for excluding garbage words;
circuitry for creating a database of words read from the digital file exclusive of the garbage words; and
circuitry for performing the search query on the database of words.

23. The system as recited in claim 20, further comprising:
circuitry for displaying an image of the selected portion to a user accessing the webbox.

24. An information clipping method comprising the steps of:
receiving a digital file of a publication;
selecting a page of the publication accessed from the digital file, wherein the page contains an advertisement;
performing a software clipping of the advertisement; and
outputting an electronic file of the advertisement clipped from the page of the publication.

25. The method as recited in claim 24, wherein the outputting step further comprises the step of downloading the electronic file of the advertisement clipped from the page of the publication to a webbox.

26. The method as recited in claim 25, further comprising the step of displaying an image of the advertisement to a user accessing the webbox.

27. The method as recited in claim 24, wherein the outputting step further comprises the step of emailing the electronic file of the advertisement clipped from the page of the publication to an advertiser associated with the advertisement.

28. A system comprising:
circuitry for receiving a digital file of a publication;
circuitry for selecting a page of the publication accessed from the digital file, wherein the page contains an advertisement;
circuitry for performing a software clipping of the advertisement; and
circuitry for downloading the advertisement clipped from the page of the publication to an advertiser.

29. The system as recited in claim 28, wherein the downloading of the electronic file of the advertisement clipped from the page of the publication is performed to a webbox.
